(19) United States
(12) Patent Application Publication
(10) Pub. No.: US 2023/0249505 A1
(43) Pub. Date: Aug. 10, 2023

(54) COVERING AND CONTAINMENT APPARATUS

(71) Applicant: WILLIAM R. MILLWOOD, Grand Rapids, MI (US)

(72) Inventor: WILLIAM R. MILLWOOD, Grand Rapids, MI (US)

(21) Appl. No.: 18/167,061

(22) Filed: Feb. 9, 2023

Related U.S. Application Data
(60) Provisional application No. 63/308,551, filed on Feb. 10, 2022.

(51) Int. Cl. B60D 1/60

(52) U.S. Cl. CPC B60D 1/605

(57) ABSTRACT

A containment apparatus for at least partially covering or containing a male trailer hitch, one or more balls attached thereto, or any portion of the vehicle's hitch assembly VHA including the female receiver for receivingly engaging the male trailer hitch. A sheet material is provided to form a conduit-like structure with opposing ends having closure mechanism's for permitting the selective and incremental opening/closing thereof.

### CROSS-REFERENCE TO RELATED APPLICATION

This application claims priority to U.S. Provisional Patent Application Ser. No. 63/308,551 filed Feb. 10, 2022, the entirety of which is incorporated by reference herein.

### TECHNICAL FIELD

The present invention relates generally to the field of containment and covering apparatuses, and more particularly to containment or covering apparatuses for tools, automotive accessories, trailer hitch components and the like.

### BACKGROUND

Most receiver hitches, when in use, have working parts such that loads applied thereto and friction generated thereby create surfaces that are covered in residue, and can be greasy, oily, or otherwise comprise one or more dirty surfaces that are certainly capable of staining one or more portions of the vehicle's interior, for example, when the hitch is desired to be removed from the vehicle's hitch. For example, the female receiver is generally mounted to a vehicle and a male hitch is removably attachable to the female receiver. A towing ball can be mounted (removable or permanent) to the male hitch, which is received by the female tongue coupler of a trailer.

Hitches in regular use sometimes benefit from light lubrication to reduce friction and increase longevity, but under these circumstances the hitch becomes dirty to the touch while handling. In addition, dust, dirt, and general road grime cling to these components creating a messy device when you are ready to remove and store until its next use. Continued improvements to receivers and hitches for maintaining their cleanliness are sought. It is to the provision of a covering and containment apparatus meeting these and other needs that the present invention is primarily directed.

### SUMMARY

In example embodiments, the present invention provides a covering and containment apparatus for a vehicle's trailer hitch assembly, for example, at least the male hitch (and ball attached thereto).

According to one aspect, the present invention relates to a containment apparatus including an enclosure formed from at least one sheet material, the enclosure including an internal volume and first and second ends, at least one opening provided at the first and second ends, and a closure mechanism at the first and second ends so as to permit selective opening and closing of the at least one opening.

In example embodiments, the containment apparatus is configured for at least partially receiving a male hitch within at least a portion of the internal volume. In example embodiments, the containment apparatus is configured for at least partially coving a male hitch, regardless of whether the male hitch is connected with a vehicle hitch assembly or disconnected for storage.

In another aspect, the present invention relates to a cover for a male hitch including at least one sheet material forming an enclosure defining an interior volume and including first and second ends. In example embodiments, the first and second ends include closure mechanisms so as to provide for the selective opening and closing thereof. In example embodiments, the enclosure is sized and shaped to accommodate a male hitch fitted within the internal volume.

In example embodiments, the closure mechanism includes a zipper-like closure mechanism. In example embodiments, the closure mechanism includes hook and loop material. In example embodiments, the closure mechanism includes at least one magnetic component. In example embodiments, the closure mechanism includes a draw string.

In yet another aspect, the present invention relates to a method of using a cover for a male hitch. The method includes providing a cover including first and second ends, the first and second ends including an opening, each opening including a closure mechanism for the selective opening and closing thereof; providing a male hitch, the male hitch including a vehicle engagement portion for removable engagement with a vehicle hitch assembly and a ball mounted to at least a portion thereof for being received by a trailer coupling; and at least partially covering one or more portions of the male hitch such that the male hitch is at least partially occupying a portion of the cover's interior volume.

In example embodiments, the method may further include removably connecting the male hitch with a hitch assembly of a vehicle. In further example embodiments, the method further includes that the cover remains on the male hitch when the male hitch is removably attached to the vehicle's hitch assembly.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a male hitch mounted to a female receiver, showing a majority thereof being covered by a containment apparatus according to an example embodiment of the present invention.

FIG. 2 is a side view of the containment apparatus of FIG. 1, showing a majority of a female receiver and a male hitch connected thereto being covered thereby.

FIG. 3 is a side view of an adjustable male hitch mounted to a female receiver, showing a majority thereof being covered by a containment apparatus according to another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

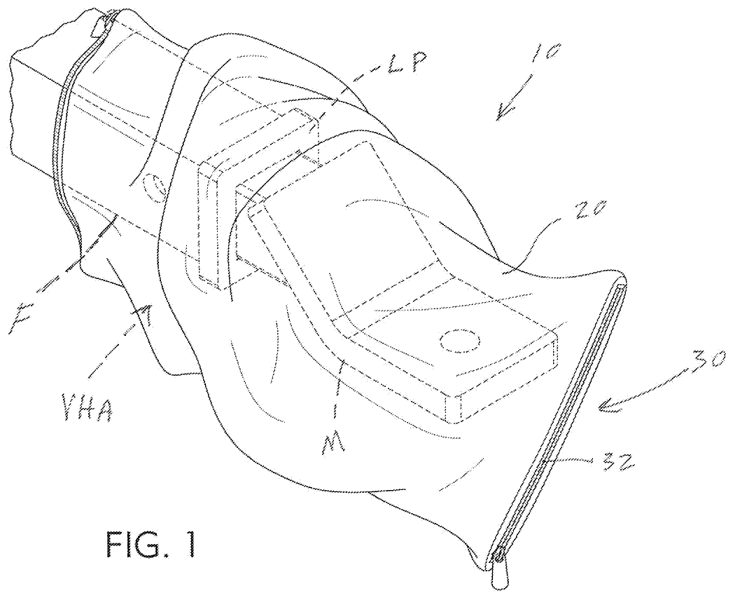

With reference now to the drawing figures, wherein like reference numbers represent corresponding parts throughout the several views, FIGS. 1-3 show a containment apparatus 10 that's removably connected to vehicle's hitch assembly VHA, for example a male hitch M that's typically removably attached to a female receiver F of the vehicle's hitch assembly VHA.

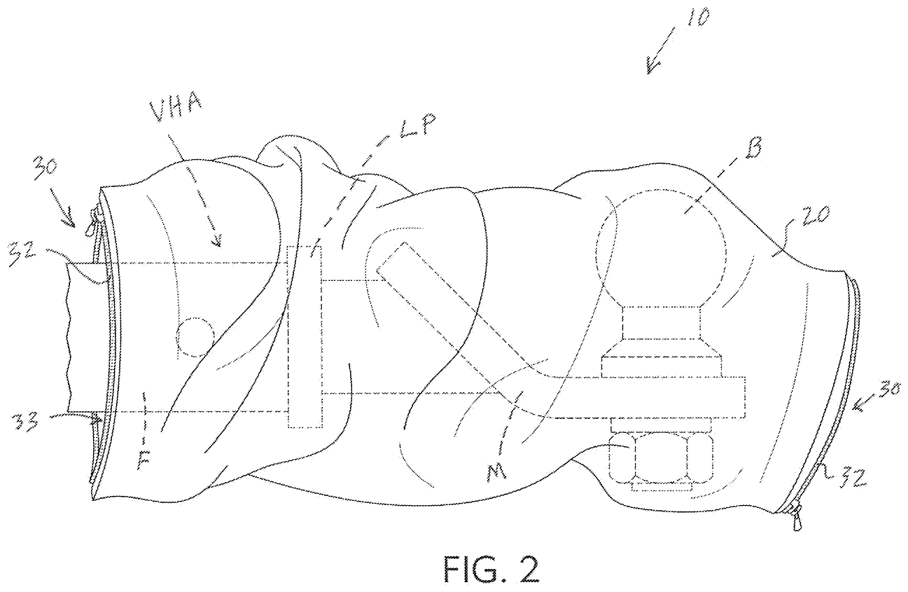

According to one example embodiment of the present invention as depicted in FIGS. 1-2, a generally flexible, durable and impermeable sheet material is provided so as to form an elongate tube-like conduit 20 comprising generally opposing ends having openings in communication therebetween, and having closure mechanisms 30 secured at the ends thereof so as to permit the selective opening or closing of the openings thereof.

According to the depicted embodiments of FIGS. 1-2, the closure mechanisms 30 are in the form of zipper-like arrangements, for example, comprising interengagement features or interconnectable components 32 along the length of the openings. In example embodiments, other closure mechanisms can be provided as desired, for example, hook and loop material, magnetics, draw string, or other closure mechanisms permitting the incremental adjustment to the size of the openings provided at the ends.

For example, according to example embodiments, the containment apparatus can comprise closure mechanism's that permit for 100% closure thereof, and for example, permit for a variable percentage of closure such that the closure mechanism can tension itself tightly around at least a portion of the vehicle's hitch assembly VHA so as to provide for secure removable engagement thereto while also ensuring that moisture or other unwanted dirt and grime does not have access to the covered or contained portion thereof within the confines of the containment apparatus 10 (e.g., space within the conduit 20).

For example, as depicted in FIGS. 1-2, the containment apparatus 10 is configured for covering a male hitch M that's removably mounted to a vehicle's female receiver F. Accordingly, with one of the closure mechanism's 30 disengaged to permit the maximum opening size, the free end of the male hitch M is received within the opening provided by the disengaged closure mechanism 30, and the conduit 20 is generally moved along until the open end can extend no further. According to some example embodiments, the length or extension of the conduit 20 is such that only a portion of the male hitch M (and ball B attached thereto) is capable of being covered or contained thereby. According to other example embodiments such as those depicted in FIGS. 1-2, the length of the conduit 20 is sufficient so as to permit tensioning of the closure mechanism around at least a portion of the female receiver F. According to one example embodiment, the length of the conduit is at least sufficient so as to extend from an end of the male hitch M to at least a position on the female receiver F that's beyond a lip portion LP thereof.

In example embodiments, the conduit 20 can be provided in any desired sheet material, for example, textiles, fabrics, impermeable fabrics, durable fabrics comprising one or more threads formed from natural and/or synthetic yarns (or a combination thereof), for example, comprising a desired fiber structure and profile. According to example embodiments, the containment apparatus can comprise a conduit comprising one or more enhanced characteristics such as the sheet material being stretchable and deformable, for example, by up to about 50% so as to conform to various vehicle hitch assemblies VHA, female receivers F and removably connected male hitch M (and ball B or multiple balls). According to some example embodiments, the conduit or material(s) forming the conduit can be cut and sewn according to a particular pattern or profile to adapt or match the size (e.g., length, width, and extension) and profile of the male hitch as desired. Furthermore, the manufacturing and assembly processes may be adapted accordingly.

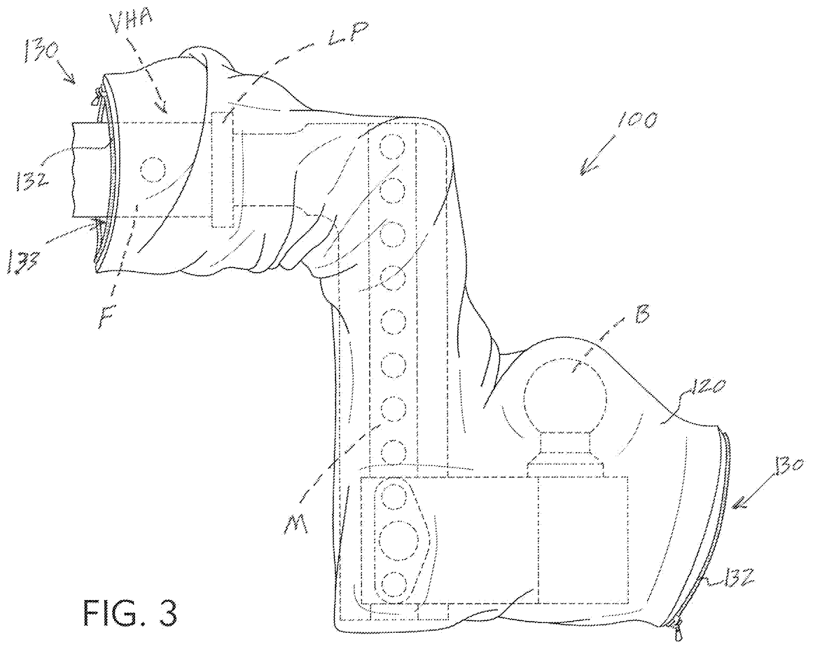

For example, as depicted in FIG. 3, the containment apparatus 100 comprises a generally elongate and deformable conduit 120 for covering an adjustable male hitch AH that's removably connected to a female receiver F of a vehicle's hitch assembly VHA. As similarly described above, the conduit 120 can be shaped as desired and can be formed from a desirable sheet material or other material capable of containing or covering the male hitch M (and ball B). closure mechanisms 130 are provided at opposing ends of the conduit 120.

According to example embodiments, the closure mechanisms of the present invention can be configured as desired, for example, for both facilitating the storage and containment of the male hitch H (and ball B or balls) while not connected to the vehicle's hitch assembly VHA, and for example, at least partially protecting one or more portions of the male hitch H (and ball B or balls) while being connected to the vehicle's hitch assembly VHA. According to one example embodiment, the containment apparatus comprises a first type of closure mechanism at a first end and a second type of closure mechanism at a second end thereof. According to one example embodiment, the first type of closure mechanism comprises a drawstring-type closure mechanism that defines an opening capable of being infinitely adjustable between a fully open configuration and a fully closed or substantially closed configuration. Furthermore, the second type of closure mechanism comprises opposing pairs of interengagement features, for example, zipper teeth, hook and loop, magnets and ferro magnetic materials, or other interconnectable or interengageable components to permit removable attachment therebetween. Accordingly, when using the containment apparatus as a storage bag to contain the male hitch M (and ball B or balls), the second type of closure mechanism can remain at least substantially closed, and the male hitch M (and ball B) can be inserted within the opening of the first type of closure mechanism. With the containment apparatus covering the male hitch M (and ball B), the first type of closure mechanism can be opened to permit passage of the male hitch M therethrough for engagement with the vehicle's hitch assembly VHA, and the second type of closure mechanism can be at least partially disengaged to permit passage of the ball therethrough.

Thus, according to example embodiments, the containment apparatus is versatile in that it can function to fully contain a male hitch M (and ball B) when not attached to the vehicle, and for example, can remain at least partially covering a portion of the male hitch M (and ball B) when the male hitch M is removably engaged with the vehicle's hitch assembly VHA. Thus, according to some example embodiments, the containment apparatuses as described herein can act as a multifunctional and protective sleeve, the sleeve generally at least partially covering the male hitch M the entirety of the time thereof, regardless of whether the hitch is removably connected with the vehicle's hitch assembly VHA or removed therefrom for storage.

In yet another aspect, the present invention relates to a method of using a cover for a male hitch. The method includes providing a cover including first and second ends, the first and second ends including an opening, each opening including a closure mechanism for the selective opening and closing thereof; providing a male hitch, the male hitch including a vehicle engagement portion for removable engagement with a vehicle hitch assembly and a ball mounted to at least a portion thereof for being received by a trailer coupling; and at least partially covering one or more portions of the male hitch such that the male hitch is at least partially occupying a portion of the cover's interior volume.

In example embodiments, the method may further comprise removably connecting the male hitch with a hitch assembly of a vehicle. In further example embodiments, the cover may remain on the male hitch when the male hitch is removably attached to the vehicle's hitch assembly, regardless of whether the male hitch is in use or not.

While the invention has been described with reference to example embodiments, it will be understood by those skilled in the art that a variety of modifications, additions and deletions are within the scope of the invention, as defined by the following claims.

What is claimed is:

1. A containment apparatus comprising:
an enclosure formed from at least one sheet material, the enclosure comprising an internal volume and first and second ends;
at least one opening provided at the first and second ends; and
a closure mechanism at the first and second ends so as to permit selective opening and closing of the at least one opening.

2. The containment apparatus of claim 1, wherein the containment apparatus is configured for at least partially receiving a male hitch within at least a portion of the internal volume.

3. The containment apparatus of claim 2, wherein the containment apparatus is configured for at least partially coving a male hitch, regardless of whether the male hitch is connected with a vehicle hitch assembly or disconnected for storage.

4. A cover for a male hitch, the cover comprising at least one sheet material forming an enclosure defining an interior volume and comprising first and second ends, and wherein the first and second ends comprise closure mechanisms so as to provide for the selective opening and closing thereof.

5. The cover of claim 4, wherein the enclosure is sized and shaped to accommodate a male hitch fitted within the internal volume.

6. The cover of claim 4, wherein the closure mechanism comprises a zipper-like closure mechanism.

7. The cover of claim 4, wherein the closure mechanism comprises hook and loop material

8. The cover of claim 4, wherein the closure mechanism comprises at least one magnetic component.

9. The cover of claim 4, wherein the closure mechanism comprises a draw string.

10. A method of using a cover for a male hitch, the method comprising:
providing a cover comprising first and second ends, the first and second ends comprising an opening, each opening comprising a closure mechanism for the selective opening and closing thereof;
providing a male hitch, the male hitch comprising a vehicle engagement portion for removable engagement with a vehicle hitch assembly and a ball mounted to at least a portion thereof for being received by a trailer coupling; and
at least partially covering one or more portions of the male hitch such that the male hitch is at least partially occupying a portion of the cover's interior volume.

11. The method of claim 10, further comprising removably connecting the male hitch with a hitch assembly of a vehicle.

12. The method of claim 11, wherein the cover remains on the male hitch when the male hitch is removably attached to the vehicle's hitch assembly.
